(19) United States
(12) Patent Application Publication
(10) Pub. No.: US 2025/0028276 A1
(43) Pub. Date: Jan. 23, 2025

(54) IMAGE CARRIER UNIT AND IMAGE FORMING APPARATUS

(71) Applicant: FUJIFILM BUSINESS INNOVATION CORP., Tokyo (JP)

(72) Inventors: Kota FURUHATA, Kanagawa (JP); Atsushi KANEKO, Kanagawa (JP); Yosuke NINOMIYA, Kanagawa (JP)

(73) Assignee: FUJIFILM BUSINESS INNOVATION CORP., Tokyo (JP)

(21) Appl. No.: 18/443,757

(22) Filed: Feb. 16, 2024

(30) Foreign Application Priority Data
Jul. 21, 2023 (JP) 2023-119180

(51) Int. Cl. G03G 21/00; G03G 15/00; G03G 15/01; G03G 15/08; G03G 21/10

(52) U.S. Cl. CPC G03G 21/0011; G03G 15/0142; G03G 15/0806; G03G 15/5016; G03G 21/105

(57) ABSTRACT

An image carrier unit includes an image carrier configured to carry an image on a surface of the image carrier, a removal member configured to remove an adherent adhering to the surface of the image carrier, a transporter configured to transport the adherent removed by the removal member in an axial direction by axial rotation to discharge the adherent, and a grip portion to be gripped by a user to insert the image carrier unit into or remove the image carrier unit from an image forming apparatus configured to form, on a recording medium, the image on the image carrier. The grip portion includes a recessed portion that constitutes an outer surface while receding toward the transporter in a cross section intersecting the axial direction of the transporter, and has a curved wall serving as a partition from the transporter.

### CROSS-REFERENCE TO RELATED APPLICATIONS

This application is based on and claims priority under 35 USC 119 from Japanese Patent Application No. 2023-119180 filed Jul. 21, 2023.

### BACKGROUND

### (i) Technical Field

The present disclosure relates to an image carrier unit and an image forming apparatus.

### (ii) Related Art

For example, Japanese Unexamined Patent Application Publication No. 2009-93099 discloses an electrophotographic image forming apparatus including a collector that collects a detachable unit containing a toner and/or a carrier by enclosing the unit when replacing the unit.

### SUMMARY

Aspects of non-limiting embodiments of the present disclosure relate to the following circumstances. To insert an image carrier unit into or remove the image carrier unit from an image forming apparatus by holding a grip portion of the image carrier unit, the grip portion of the image carrier unit may be provided so that the user's hand is not stained. If the grip portion is a separate member, the external size of the image carrier unit increases and the size of a housing space in the image forming apparatus is not easily reduced. Thus, it is difficult to achieve space saving.

Aspects of non-limiting embodiments of the present disclosure therefore relate to achievement of space saving compared with a case where the grip portion is provided as a separate member.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an image carrier unit comprising: an image carrier configured to carry an image on a surface of the image carrier; a removal member configured to remove an adherent adhering to the surface of the image carrier; a transporter configured to transport the adherent removed by the removal member in an axial direction by axial rotation to discharge the adherent; and a grip portion to be gripped by a user to insert the image carrier unit into or remove the image carrier unit from an image forming apparatus configured to form, on a recording medium, the image on the image carrier, wherein the grip portion comprises a recessed portion that constitutes an outer surface while receding toward the transporter in a cross section intersecting the axial direction of the transporter, and has a curved wall serving as a partition from the transporter.

### BRIEF DESCRIPTION OF THE DRAWINGS

An exemplary embodiment of the present disclosure will be described in detail based on the following figures, wherein:

FIG. 1 is a schematic structural diagram of an image forming apparatus according to an exemplary embodiment;

FIG. 2 illustrates the structure of a photoconductor unit;

FIG. 3 is a sectional view illustrating the photoconductor unit;

FIG. 4 illustrates an example of how a user holds the photoconductor unit to insert the photoconductor unit into or remove the photoconductor unit from the image forming apparatus;

FIG. 5 is a partially enlarged sectional view of the photoconductor unit for description of a first operation portion;

FIG. 6 is a perspective view of a housing from the first operation portion side;

FIG. 7 is a partial perspective view illustrating a first operation portion according to a modification;

FIG. 8 illustrates the posture of the photoconductor unit that is pulled from the image forming apparatus; and

FIG. 9 illustrates the posture of the photoconductor unit that is pulled from the image forming apparatus.

### DETAILED DESCRIPTION

An exemplary embodiment of the disclosure is described in detail below with reference to the accompanying drawings. The sizes and thicknesses of components in the drawings to be referred to in the following description may differ from actual dimensions.

### <Image Forming Apparatus 100>

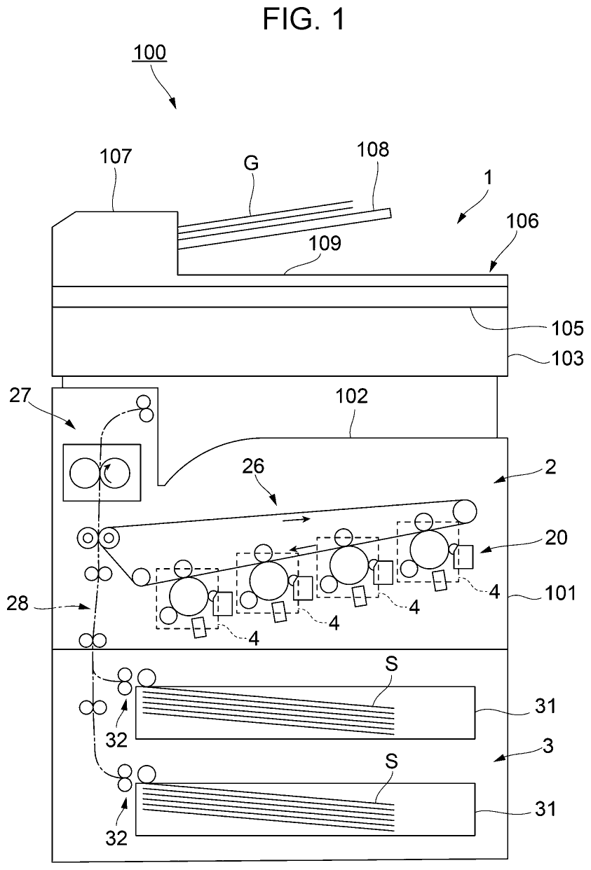

FIG. 1 is a schematic structural diagram of an image forming apparatus 100 according to this exemplary embodiment.

As illustrated in FIG. 1, the image forming apparatus 100 includes a document reading device 1 that reads information on a document G, an image former 2 that forms an image on recording paper S based on the information on the document read by the document reading device 1 (read image), and a paper feeder 3 that sends the recording paper S to be fed to the image former 2. In the image forming apparatus 100, the image former 2 and the paper feeder 3 are housed in a body 101, and the document reading device 1 is disposed above the body 101. The body 101 includes, at its top, an output paper receiver 102 that receives the output recording paper S on which the image is formed.

The document reading device 1 includes a housing 103. The document reading device 1 includes, at the top of the housing 103, a light transmissive document stage 105 on which the document G is placed, and a document cover 106 that covers the document stage 105 and is openable and closable relative to the housing 103. The document cover 106 has an automatic document feeder 107 that transports the document G to a reading position and outputs the read document G, a document tray 108 on which the document G to be sent by the automatic document feeder 107 is placed, and a receiver 109 that receives the document G output by the automatic document feeder 107.

The image former 2 includes an image forming unit 20 that forms yellow (Y), magenta (M), cyan (C), and black (K) toner images by, for example, an electrophotographic system, an intermediate transfer unit 26 that transports the toner images formed by the image forming unit 20 until they are transferred onto the recording paper S, and a fixing unit 27 that fixes the toner images transferred onto the recording paper S from the intermediate transfer unit 26.

The image forming unit 20 includes photoconductor units 4 associated with the individual colors and represented by broken lines. Each photoconductor unit 4 is attachable to and removable from the body 101 by a user.

The paper feeder 3 includes drawable containers 31 that contain a plurality of sheets of recording paper S in preset sizes, types, etc., and feeding devices 32 that send the sheets of recording paper S contained in the containers 31 one by one to transport paths. A feeding and transport path 28 is provided between the paper feeder 3 and the image former 2 to transport the recording paper S sent from the paper feeder 3 to a second transfer position.

Next, a basic operation of the image forming apparatus 100 is described.

In the document reading device 1, the user places the document G on the document stage 105 or the document tray 108. When the user operates an operation button (not illustrated) etc. and the document reading device 1 receives a document reading instruction, the document reading device 1 starts an operation of reading the document G. That is, the document reading device 1 acquires read information on the document G. The image former 2 performs an image forming operation based on the read information on the document G received from the document reading device 1. In synchronization with the operation of the image former 2, the paper feeder 3 sends out the recording paper S. After the toner images are fixed by the image former 2, the recording paper S is output to the output paper receiver 102. The image forming operation is repeated for the number of documents G or the number of images to be formed.

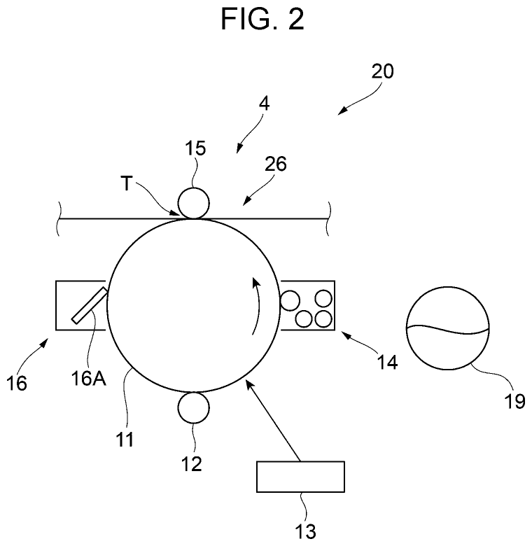

Next, the image forming unit 20 according to this exemplary embodiment is described with reference to FIG. 2. More specifically, each photoconductor unit 4 constituting the image forming unit 20 is described. The photoconductor unit 4 is an example of an image carrier unit.

FIG. 2 illustrates the structure of the photoconductor unit 4 that is viewed from the front side of the image forming apparatus 100.

As illustrated in FIG. 2, the photoconductor unit 4 includes a photoconductor drum 11 that rotates in an arrow direction. The photoconductor unit 4 includes a charging roller 12, an exposing device 13, a developing device 14, a transfer roller 15, and a cleaning device 16 as members disposed around the photoconductor drum 11. The photoconductor unit 4 may have all of these members but part of the members may be omitted.

The photoconductor drum 11 is a cylinder. A photoconductive layer (not illustrated) is formed on the surface of the cylinder.

The charging roller 12 is a conductive rubber roller etc. and charges the photoconductor drum 11.

The exposing device 13 irradiates the photoconductor drum 11 charged by the charging roller 12 with light from a laser light source, a light emitting diode (LED) light source, etc. to form an electrostatic latent image on the surface of the photoconductor drum 11.

The developing device 14 causes a toner to adhere to the surface of the photoconductor drum 11 to develop the electrostatic latent image formed on the photoconductor drum 11 with the toner in a predetermined color. In this way, a toner image is formed on the surface of the photoconductor drum 11 in this exemplary embodiment.

The developing device 14 contains a developer. In this exemplary embodiment, the developer is a so-called two-component developer composed of a magnetic carrier and a colored toner.

In this exemplary embodiment, a developer container 19 contains the developer to be supplied to the developing device 14. In this exemplary embodiment, a new developer is supplied from the developer container 19 to the developing device 14 through a developer transport path (not illustrated).

The transfer roller 15 is a conductive rubber roller etc.

In this exemplary embodiment, the transfer roller 15 and the photoconductor drum 11 face each other to define a transfer portion T. A transfer bias is applied to the transfer roller 15. The toner image on the surface of the photoconductor drum 11, that is, the toner image carried by the photoconductor drum 11 is transferred onto a belt of the intermediate transfer unit 26 at the transfer portion T.

The cleaning device 16 includes a contact member 16A disposed in contact with the photoconductor drum 11, and removes adherents such as a toner on the photoconductor drum 11.

Next, a specific structure of the photoconductor unit 4 is described.

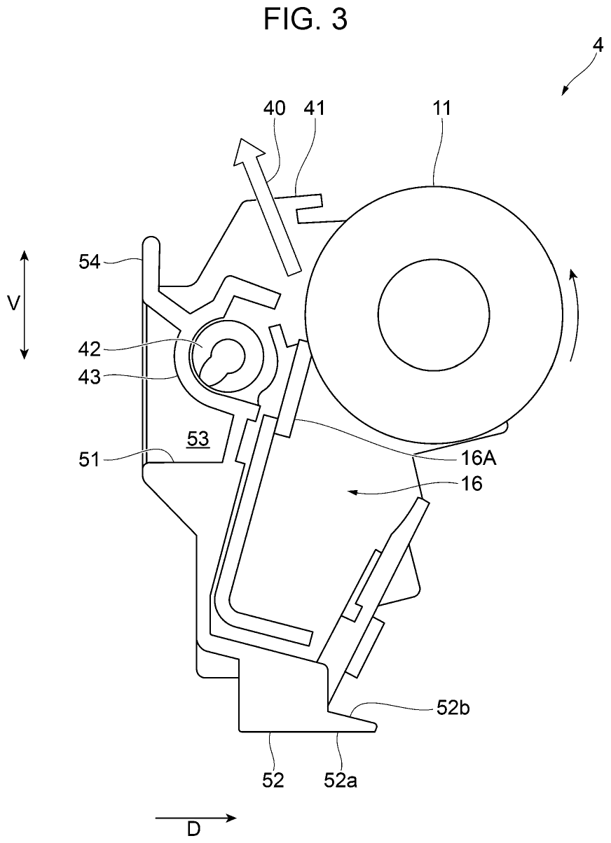

FIG. 3 is a sectional view illustrating the photoconductor unit 4.

The photoconductor unit 4 illustrated in FIG. 3 includes a housing 41 and a transport auger 42 in addition to the photoconductor drum 11 and the cleaning device 16.

The housing 41 is a member serving as the body of the photoconductor unit 4, and rotatably supports the photoconductor drum 11 and the transport auger 42. More specifically, the housing 41 supports the photoconductor drum 11 and the transport auger 42 so that the rotation shaft of the photoconductor drum 11 and the rotation shaft of the transport auger 42 extend in the same direction. The rotation shafts of the photoconductor drum 11 and the transport auger 42 extend in a direction perpendicular to the drawing sheet.

The housing 41 includes a wall 43 positioned below the transport auger 42 to define a space that houses the transport auger 42. The wall 43 is positioned opposite to the photoconductor drum 11 across the transport auger 42.

The wall 43 is an example of a curved wall.

The transport auger 42 adjoins the photoconductor drum 11 and a spiral blade is attached around the rotation shaft. When the transport auger 42 rotates, adherents such as a toner removed by the cleaning device 16 are transported in one direction. The housing space for the transport auger 42 defined by the wall 43 serves as a collection path.

The transport auger 42 is an example of a transporter.

The cleaning device 16 illustrated in FIG. 3 cleans the surface of the photoconductor drum 11 by removing adherents such as a toner adhering to the surface of the photoconductor drum 11. The adherents such as a toner removed by the contact member 16A of the cleaning device 16 are collected on the collection path but partially scattered in a toner scattering direction 40.

The contact member 16A of the cleaning device 16 is an example of a removal member.

The housing 41 is described in more detail. The housing 41 includes a first operation portion 51 and a second operation portion 52 to be operated by the user to insert the photoconductor unit 4 into or remove the photoconductor unit 4 from the image forming apparatus 100.

The first operation portion 51 is provided at the middle position in a vertical direction V of the housing 41, and the second operation portion 52 is provided at a lower part of the housing 41. The first operation portion 51 is formed in a space 53 separated from the transport auger 42 by the wall 43. The space 53 for the first operation portion 51 recedes from the outer surface in a receding direction D toward the transport auger 42.

The cross section illustrated in FIG. 3 intersects the axial direction of the transport auger 42. The wall 43 and a bottom surface 44 described later that define the space 53 for the first operation portion 51 are examples of a recessed portion that constitutes the outer surface while receding toward the transport auger 42.

The housing 41 includes a restrictor 54 that is positioned above the first operation portion 51 and restricts movement of the toner scattered in the toner scattering direction 40 toward the space 53. The restrictor 54 is shaped to extend upward in the vertical direction V and also extend in the toner scattering direction 40, and is formed along the axial direction of the transport auger 42 (direction perpendicular to the drawing sheet).

The second operation portion 52 is positioned at the lower part of the housing 41 and has a flat surface 52a. The second operation portion 52 has a protrusion 52b that protrudes in a direction opposite to the first operation portion 51 to enlarge the surface 52a.

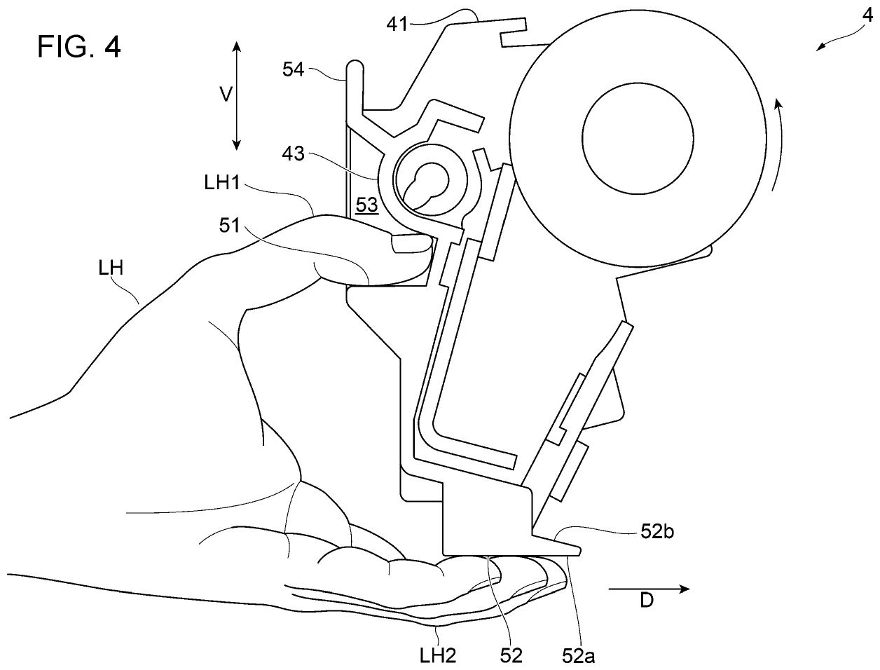

FIG. 4 illustrates an example of how the user holds the photoconductor unit 4 to insert the photoconductor unit 4 into or remove the photoconductor unit 4 from the image forming apparatus 100.

When the user holds the photoconductor unit 4, for example, with his/her left hand LH as illustrated in FIG. 4, a thumb LH1 may be put on the first operation portion 51 and the four remaining fingers LH2 may support the second operation portion 52 from below.

The space 53 is not positioned in the toner scattering direction 40 (see FIG. 3), and the toner adhesion amount is reduced by the restrictor 54 (see FIG. 3) corresponding to the toner scattering direction 40.

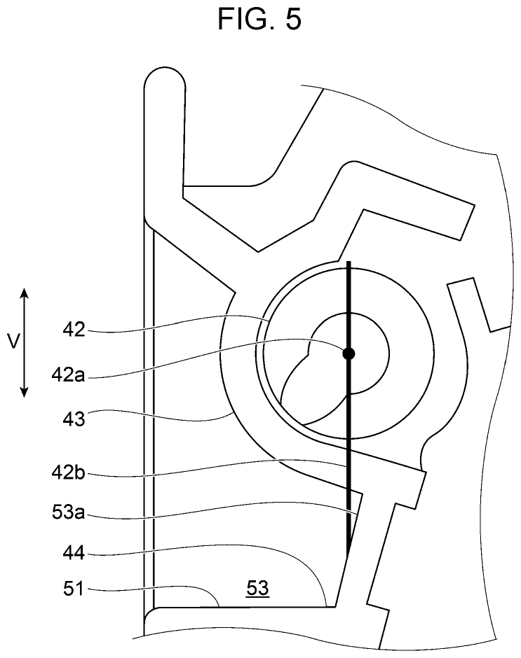

FIG. 5 is a partially enlarged sectional view of the photoconductor unit 4 for description of the first operation portion 51.

As illustrated in FIG. 5, the first operation portion 51 is formed by using the wall 43. More specifically, the first operation portion 51 is formed by the wall 43 and the bottom surface 44. As illustrated in FIG. 5, the wall 43 and the bottom surface 44 are disposed at different positions in the vertical direction, and the wall 43 is positioned above the bottom surface 44 in the vertical direction V. The bottom surface 44 faces the wall 43, and is an example of a facing wall.

The wall 43 serves as a partition from the transport auger 42, and is curved to project toward the space 53. The wall 43 is formed so that the thickness does not change in the cross section.

The bottom surface 44 of the wall 43 includes a portion 53a positioned deeper than a straight line 42b including a rotation axis 42a of the transport auger 42 and extending in the vertical direction V. The portion 53a is part of the bottom surface 44 but may be the entire bottom surface 44.

The bottom surface 44 according to this exemplary embodiment is positioned deeper than the position of the rotation axis 42a.

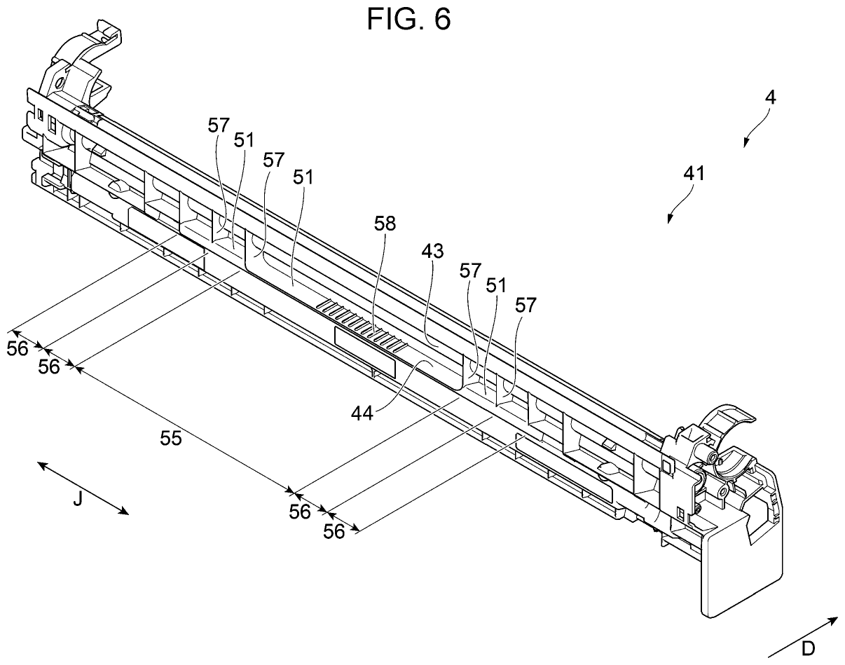

FIG. 6 is a perspective view of the housing 41 from the first operation portion 51 side.

As illustrated in FIG. 6, the first operation portion 51 includes a first region 55 that is long in an axial direction J of the transport auger 42 (see, for example, FIG. 3), and second regions 56 that are short in the axial direction J. A reinforcing portion 57 connected to the wall 43 is formed at a boundary position between the first region 55 and each second region 56.

As illustrated in FIG. 6, the first operation portion 51 has ribs 58 on the bottom surface 44 that faces the wall 43. The ribs 58 extend in the receding direction D. The ribs 58 increase the area of contact with the user's finger.

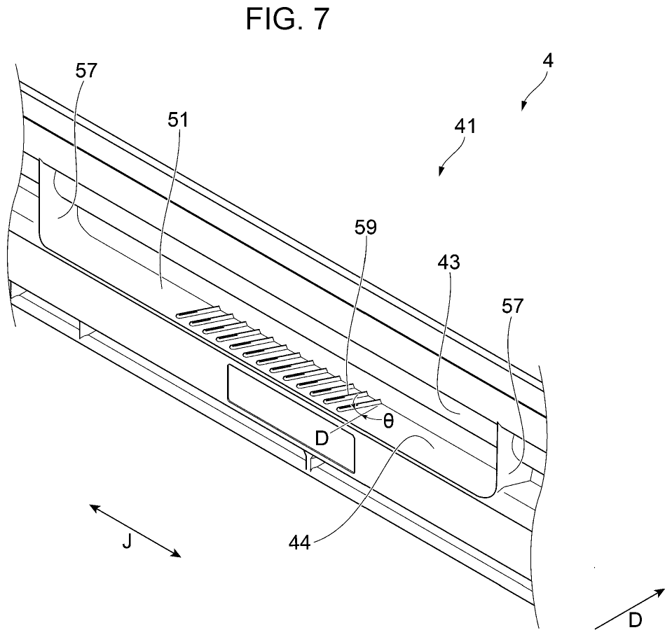

FIG. 7 is a partial perspective view illustrating a first operation portion 51 according to a modification, and illustrates the housing 41 that is viewed from the first operation portion 51 side as in FIG. 6.

The first operation portion 51 according to the modification illustrated in FIG. 7 has ribs 59 on the bottom surface 44 in place of the ribs 58 (see FIG. 6) extending in the receding direction D. The ribs 59 extend in a direction intersecting the receding direction D at an angle θ. The ribs 59 extend in an oblique direction with respect to the receding direction D, and increase the area of contact with the user's finger.

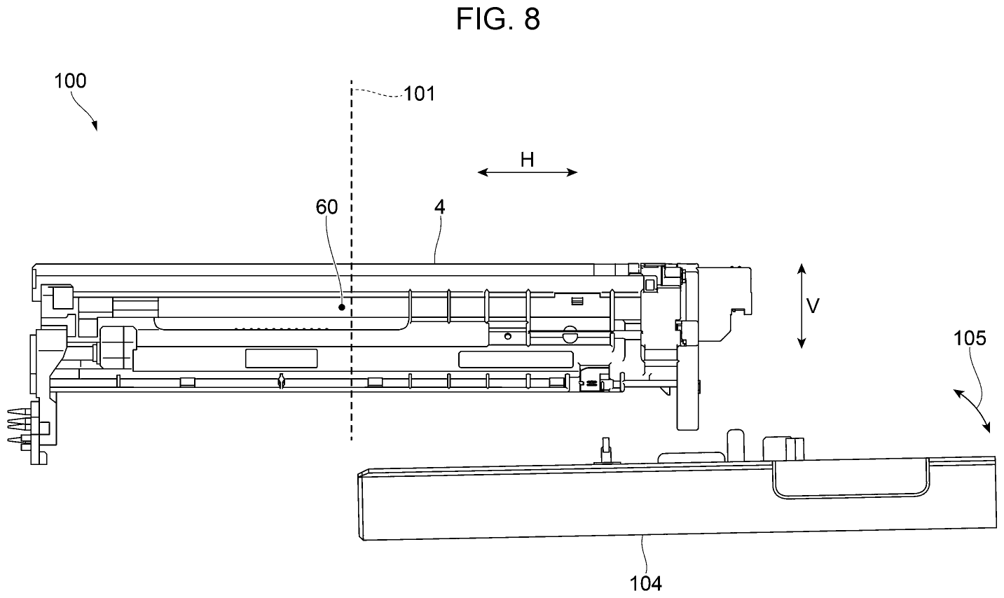

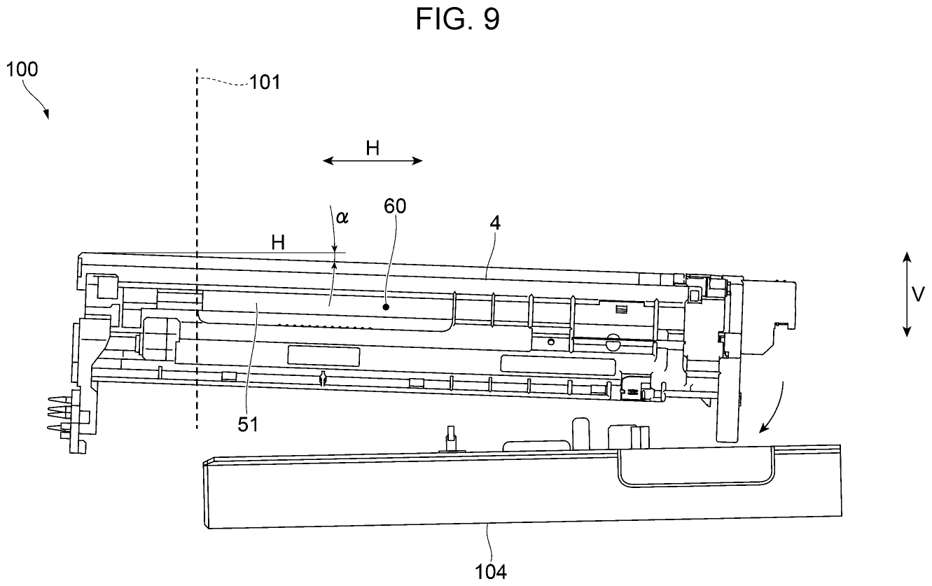

Next, the posture of the photoconductor unit 4 that is pulled from the body 101 of the image forming apparatus 100 is described with reference to FIGS. 8 and 9. For example, the photoconductor unit 4 is pulled by the user's right hand and the first operation portion 51 is held by the user's left hand.

FIGS. 8 and 9 illustrate the postures of the photoconductor unit 4 that is pulled from the image forming apparatus 100.

If the photoconductor unit 4 is pulled from the body 101 in a pulling direction H and a center of gravity 60 of the photoconductor unit 4 is within the body 101 as illustrated in FIG. 8, the posture relative to the body 101 before the pulling is maintained.

If the photoconductor unit 4 is further pulled and the center of gravity 60 is no longer within the body 101 as illustrated in FIG. 9, the front side of the photoconductor unit 4 in the pulling direction H moves down by its weight and the photoconductor unit 4 is inclined by an inclination angle α unlike FIG. 8.

In this exemplary embodiment, the posture of the photoconductor unit 4 thus changes depending on the position of the center of gravity 60 relative to the body 101 when the photoconductor unit 4 is pulled in the pulling direction H. In other words, the photoconductor unit 4 pulled in the direction H from the image forming apparatus 100 to a predetermined position is inclined by its weight relative to the image forming apparatus 100.

The pulling direction H is an example of a direction of pulling, and the position where the center of gravity 60 of the photoconductor unit 4 is no longer within the body 101 of the image forming apparatus 100 is an example of the predetermined position.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### <Appendix>

(((1)))

An image carrier unit comprising:
an image carrier configured to carry an image on a surface of the image carrier;
a removal member configured to remove an adherent adhering to the surface of the image carrier;
a transporter configured to transport the adherent removed by the removal member in an axial direction by axial rotation to discharge the adherent; and
a grip portion to be gripped by a user to insert the image carrier unit into or remove the image carrier unit from an image forming apparatus configured to form, on a recording medium, the image on the image carrier,
wherein the grip portion comprises a recessed portion that constitutes an outer surface while receding toward the transporter in a cross section intersecting the axial direction of the transporter, and has a curved wall serving as a partition from the transporter.
   (((2)))

The image carrier unit according to (((1))), wherein the recessed portion is formed so that a thickness of the curved wall in the cross section does not change.

(((3)))

The image carrier unit according to (((1))) or (((2))), wherein the recessed portion has a bottom surface positioned deeper than a position of a rotation axis of the transporter.

(((4)))

The image carrier unit according to any one of (((1))) to (((3))), wherein the grip portion comprises a reinforcing portion connected to the curved wall.

(((5)))

The image carrier unit according to (((4))),
wherein the recessed portion comprises a first region in which a length in the axial direction is larger, and a second region in which the length in the axial direction is smaller, and
wherein the reinforcing portion is formed at a boundary position between the first region and the second region.
   (((6)))

The image carrier unit according to any one of (((1))) to (((3))), wherein a rib extending in a receding direction of the recessed portion in the cross section is formed on a facing wall that faces the curved wall in the cross section.

(((7)))

The image carrier unit according to (((6))), wherein the rib extends in a direction intersecting the receding direction.

(((8)))

The image carrier unit according to any one of (((1))) to (((3))), wherein the image carrier unit is inclined by a weight of the image carrier unit relative to the image forming apparatus when the image carrier unit is pulled to a predetermined position in a direction in which the image carrier unit is pulled from the image forming apparatus.

(((9)))

An image forming apparatus comprising:
an image former configured to form an image; and
an image carrier unit that constitutes the image former and is insertable into and removable from an apparatus body including the image former,
wherein the image carrier unit comprises:
   an image carrier configured to carry an image on a surface of the image carrier;
   a removal member configured to remove an adherent adhering to the surface of the image carrier;
   a transporter configured to transport the adherent removed by the removal member in an axial direction by axial rotation to discharge the adherent; and
   a grip portion to be gripped by a user to insert the image carrier unit into or remove the image carrier unit from the apparatus body, and
wherein the grip portion comprises a recessed portion that constitutes an outer surface while receding toward the transporter in a cross section intersecting the axial direction of the transporter, and has a curved wall serving as a partition from the transporter.

What is claimed is:

1. An image carrier unit comprising:
an image carrier configured to carry an image on a surface of the image carrier;
a removal member configured to remove an adherent adhering to the surface of the image carrier;
a transporter configured to transport the adherent removed by the removal member in an axial direction by axial rotation to discharge the adherent; and
a grip portion to be gripped by a user to insert the image carrier unit into or remove the image carrier unit from an image forming apparatus configured to form, on a recording medium, the image on the image carrier,
wherein the grip portion comprises a recessed portion that constitutes an outer surface while receding toward the transporter in a cross section intersecting the axial direction of the transporter, and has a curved wall serving as a partition from the transporter.

2. The image carrier unit according to claim 1, wherein the recessed portion is formed so that a thickness of the curved wall in the cross section does not change.

3. The image carrier unit according to claim 1, wherein the recessed portion has a bottom surface positioned deeper than a position of a rotation axis of the transporter.

4. The image carrier unit according to claim 1, wherein the grip portion comprises a reinforcing portion connected to the curved wall.

5. The image carrier unit according to claim 4,
wherein the recessed portion comprises a first region in which a length in the axial direction is larger, and a second region in which the length in the axial direction is smaller, and
wherein the reinforcing portion is formed at a boundary position between the first region and the second region.

6. The image carrier unit according to claim 1, wherein a rib extending in a receding direction of the recessed portion in the cross section is formed on a facing wall that faces the curved wall in the cross section.

7. The image carrier unit according to claim 6, wherein the rib extends in a direction intersecting the receding direction.

8. The image carrier unit according to claim 1, wherein the image carrier unit is inclined by a weight of the image carrier unit relative to the image forming apparatus when the image carrier unit is pulled to a predetermined position in a direction in which the image carrier unit is pulled from the image forming apparatus.

9. An image forming apparatus comprising:
an image former configured to form an image; and
an image carrier unit that constitutes the image former and is insertable into and removable from an apparatus body including the image former,
wherein the image carrier unit comprises:
an image carrier configured to carry an image on a surface of the image carrier;
a removal member configured to remove an adherent adhering to the surface of the image carrier;
a transporter configured to transport the adherent removed by the removal member in an axial direction by axial rotation to discharge the adherent; and
a grip portion to be gripped by a user to insert the image carrier unit into or remove the image carrier unit from the apparatus body, and
wherein the grip portion comprises a recessed portion that constitutes an outer surface while receding toward the transporter in a cross section intersecting the axial direction of the transporter, and has a curved wall serving as a partition from the transporter.

10. An image carrier unit comprising:
image carrying means for carrying an image on a surface of the image carrying means;
removal means for removing an adherent adhering to the surface of the image carrying means;
transport means for transporting the adherent removed by the removal means in an axial direction by axial rotation to discharge the adherent; and
grip means to be gripped by a user to insert the image carrier unit into or remove the image carrier unit from an image forming apparatus configured to form, on a recording medium, the image on the image carrying means,
wherein the grip means comprises a recessed portion that constitutes an outer surface while receding toward the transport means in a cross section intersecting the axial direction of the transport means, and has a curved wall serving as a partition from the transport means.
